(19) United States
(12) Patent Application Publication
(10) Pub. No.: US 2005/0088991 A1
(43) Pub. Date: Apr. 28, 2005

(54) Transmitting data using multi-frames

(76) Inventor: Tae-Young Kil, Seoul (KR)

Correspondence Address: Robert E. Bushnell, Suite 300, 1522 K Street, N.W., Washington, DC, 20005-1202, US

(21) Appl. No.: 10/961,158

(22) Filed: Oct. 12, 2004

(30) Foreign Application Priority Data
Oct. 27, 2003 (KR) 2003-75265

(51) Int. Cl. H04B 7/212; H04J 3/00; H04Q 7/00

(52) U.S. Cl. 370/329

(57) ABSTRACT

A base station controller and a base station in a wireless communication system transmit data using multi-frames according to frame offsets allocated to mobile terminals to which a call has been set up. During forward data transmission, the base station controller packetizes data to be sent to each mobile terminal for each frame offset to generate the multi-frames. Then, the base station controller calls a socket function to transmit the generated multi-frames to the base stations. The base station receiving the multi-frames from the base station controller performs demultiplexing to send associated data to an associated mobile terminal. During backward data transmission, the base station packetizes data received from each mobile terminal for each frame offset to generate the multi-frames. Then, the base station calls a socket function to transmit the generated multi-frames to the base station controller. The base station controller demultiplexes the multi-frames to send the data to a mobile switching center. The data is grouped according to the frame offsets and is transmitted as multi-frames, so that it is possible to reduce the number of times that the socket function is called.

### CLAIM OF PRIORITY

This application makes reference to, incorporates the same herein, and claims all benefits accruing under 35 U.S.C. 119 from an application for METHOD FOR TRANSMITTING DATA USING MULTI-FRAME IN WIRELESS COMMUNICATION SYSTEM earlier filed in the Korean Intellectual Property Office on 27 Oct. 2003 and there duly assigned Serial No. 2003-75265.

### BACKGROUND OF THE INVENTION

1. Field of the Invention

The present invention relates to transmitting data in a wireless communication system and, more particularly, to transmitting data using multi-frames between a base station and a base station controller.

2. Description of the Related Art

Although ATM communication systems are extensively used as backbone networks for wireless communication systems, Ethernet systems are increasingly being used for the backbone network.

However, if an Ethernet system is employed as the backbone network, it dramatically affects system performance during transmission if separate transmission-dedicated hardware, such as an ATM device, are not used.

That is, when the backbone network of the wireless communication system uses a Fast Ethernet arrangement, an application software module, driven in a base station controller to process voice frames, will call a socket function for sending a voice frame so that the base station controller sends the voice frame to a mobile terminal. Calling the socket function is carried out whenever a voice frame is sent to a mobile terminal.

When the application software module of the base station controller in the Fast Ethernet environment calls the socket function to send a voice frame, the process must be continuously managed until the last voice frame is sent to the base station because an IP communication environment is being utilized. This leads to a heavy load to a system driving the application software and consumes considerable process time, unlike conventional ATM systems in which subsequent tasks are carried out by the ATM device only if a voice frame to be sent is stored in the ATM device. Consequently, there is a problem in that the transfer processing capability per unit time for voice frames is degraded.

That is, transmission of voice frames in an AAL2 cell is performed without any difficulty using an ATM device while considerable time is required for transmission using a Fast Ethernet system, as compared to the ATM arrangement. Accordingly, there is a problem in that transmission of voice frames using the Fast Ethernet system causes an overrun when implementing a system having the same capacity as that of the ATM arrangement.

The following patents each discloses features in common with the present invention but do not teach or suggest the inventive features specifically recited in the present application: U.S. Patent Application No. 2002/0122411 to Zimmerman et al., entitled METHOD AND SYSTEM FOR PACKING MANAGEMENT MESSAGES IN A COMMUNICATION SYSTEM, published on Sep. 5, 2002; U.S. Patent Application No. 2002/0122395 to Bourlas et al., entitled METHOD AND APPARATUS FOR IMPLEMENTING A MAC COPROCESSOR IN A COMMUNICATION SYSTEM, published on Sep. 5, 2002; U.S. Patent Application No. 2002/0110083 to Stanwood et al., entitled METHOD FOR ALLOCATING FRACTIONAL BANDWIDTH IN A FIXED-FRAME COMMUNICATION SYSTEM, published on Aug. 15, 2002; U.S. Patent Application No. 2002/0080816 to Spinar et al., entitled METHOD AND SYSTEM FOR ADAPTIVELY OBTAINING BAND WIDTH ALLOCATION REQUESTS, published on Jun. 27, 2002; U.S. Patent Application No. 2001/0038620 to Stanwood et al., entitled METHOD AND APPARATUS FOR ALLOCATING BANDWIDTH IN A WIRELESS COMMUNICATION SYSTEM, published on Nov. 8, 2001; U.S. Patent Application No. 2001/0030956 to Chillariga et al., entitled DYNAMIC CHANNEL ALLOCATION IN MULTIPLE-ACCESS COMMUNICATION SYSTEMS, published on Oct. 18, 2001; U.S. Patent Application No. 2001/0029444 to Rydbeck et al., entitled HIGH-PERFORMANCE HALF-RATE ENCODING APPARATUS AND METHOD FOR A TDM SYSTEM, published on Oct. 11, 2001; and U.S. Patent Application No. 2002/0177455 to Lehto et al., entitled SYSTEM AND PROTOCOL FOR EXTENDING FUNCTIONALITY OF WIRELESS COMMUNICATION MESSAGING, published on Nov. 28, 2002.

### SUMMARY OF THE INVENTION

It is, therefore, an object of the present invention to provide a method of transmitting data in a wireless communication system using multi-frames, which can effectively transmit and receive voice frames by reducing system loading and processing time when a base station controller and a base station transmit data to a mobile terminal.

Another object of the present invention to provide a program storage device, readable by a machine, tangibly embodying a program of instructions executable by the machine to perform a method of transmitting data in a wireless communication system using multi-frames, which can effectively transmit and receive voice frames by reducing system loading and processing time when a base station controller and a base station transmit data to a mobile terminal.

According to the present invention for achieving the above-noted objects, a base station controller and a base station in a wireless communication system transmit data to mobile terminals to which a call has been set up, using multi-frames for their allocated frame offset.

In a forward data transmission, the base station controller packetizes data to be sent to each mobile terminal for each frame offset to produce multi-frames. Then, the base station controller calls a socket function to transmit the produced multi-frames to an associated base station. The base station, which has received the multi-frames from the base station controller, performs demultiplexing to transmit associated data to an associated mobile terminal.

In a backward data transmission, the base station produces the multi-frames by packetizing data received from respective mobile terminals, for each frame offset. Then, the base station calls the socket function to transmit the produced multi-frames to the base station controller. The base station controller demultiplexes the multi-frames to send each data to a mobile switching center.

Thus, it is possible to reduce the number of times that the socket function is called by grouping the data by each frame offset and transmitting the data in the form of multi-frames.

These and other objects may be achieved by providing a method comprising: allocating frame offsets to a plurality of mobile terminals in a base station controller, a call being set up for each of the plurality of mobile terminals; grouping data to be sent to the plurality of mobile terminals according to the frame offsets allocated in the base station controller and generating at least one multi-frame; and transmitting the generated at least one multi-frame from the base station controller to a base station.

The method can further comprise demultiplexing the at least one multi-frame received from the base station controller in the base station and transmitting associated data to associated mobile terminals.

The method can further comprise connecting the base station controller to the base station by an Internet Protocol (IP) network.

The data can include at least one of a voice frame and a data frame.

The at least one multi-frame can include information on the base station, information on at least one mobile terminal using the base station, and data to be sent to each of the plurality of mobile terminals.

The method can further comprise differently allocating the frame offsets to each base station, so that identical frame offsets are allocated to the same base station.

These and other objects may also be achieved by providing a method comprising: allocating frame offsets to a plurality of mobile terminals in a base station controller, a call being set up for each of the plurality of mobile terminals; grouping data received from the plurality of mobile terminals according to frame offsets at a base station and generating at least one multi-frame; and transmitting the generated at least one multi-frame from the base station to the base station controller.

The method can further comprise demultiplexing the at least one multi-frame in the base station controller and transmitting the demultiplexed at least one multi-frame to a mobile switching center.

The method can further comprise connecting the base station controller to the base station by an IP network.

The data can include at least one of a voice frame and a data frame.

The at least one multi-frame can include information on the base station, information on at least one mobile terminal using the base station, and data to be sent to each of the plurality of mobile terminals.

The method can further comprise differently allocating frame offsets to each base station, so that identical frame offsets are allocated to the same base station.

These and other objects may yet also be achieved by providing a method comprising: allocating frame offsets to a plurality of mobile terminals in a base station controller, a call being set up for each of the plurality of mobile terminals; forward transmitting the data, the base station controller grouping data to be transmitted to the plurality of mobile terminals according to the frame offsets to generate at least one multi-frame and calling a socket function to transmit the generated at least one multi-frame to a base station, and the base station demultiplexing the at least one multi-frame to transmit associated data to associated mobile terminals; and backward transmitting the data, the base station grouping data received from the mobile terminals according to the frame offsets to generate the at least one multi-frame and transmitting the at least one multi-frame to the base station controller through a called socket function, and the base station controller demultiplexing the at least one multi-frame and transmitting the demultiplexed at least one multi-frame to a mobile switching center.

These and other objects may still also be achieved by providing a program storage device, readable by a machine, tangibly embodying a program of instructions executable by the machine to perform a method comprising: allocating frame offsets to a plurality of mobile terminals in a base station controller, a call being set up for each of the plurality of mobile terminals; grouping data to be sent to the plurality of mobile terminals according to the frame offsets allocated in the base station controller and generating at least one multi-frame; and transmitting the generated at least one multi-frame from the base station controller to a base station.

The method can further comprise demultiplexing the at least one multi-frame received from the base station controller in the base station and transmitting associated data to associated mobile terminals.

The method can further comprise method further comprising connecting the base station controller to the base station by an Internet Protocol (IP) network.

The data can include at least one of a voice frame and a data frame.

The at least one multi-frame can include information on the base station, information on at least one mobile terminal using the base station, and data to be sent to each of the plurality of mobile terminals.

The method can further comprise differently allocating the frame offsets to each base station, so that identical frame offsets are allocated to the same base station.

These and other objects may also be achieved by providing a program storage device, readable by a machine, tangibly embodying a program of instructions executable by the machine to perform a method comprising: allocating frame offsets to a plurality of mobile terminals in a base station controller, a call being set up for each of the plurality of mobile terminals; grouping data received from the plurality of mobile terminals according to frame offsets at a base station and generating at least one multi-frame; and transmitting the generated at least one multi-frame from the base station to the base station controller.

The method can further comprise demultiplexing the at least one multi-frame in the base station controller and transmitting the demultiplexed at least one multi-frame to a mobile switching center.

The method can further comprise connecting the base station controller to the base station by an IP network.

The data can include at least one of a voice frame and a data frame.

The at least one multi-frame can include information on the base station, information on at least one mobile terminal using the base station, and data to be sent to each of the plurality of mobile terminals.

The method can further comprise differently allocating frame offsets to each base station, so that identical frame offsets are allocated to the same base station.

These and other objects may still also be achieved by providing a program storage device, readable by a machine, tangibly embodying a program of instructions executable by the machine to perform a method comprising: allocating frame offsets to a plurality of mobile 8 terminals in a base station controller, a call being set up for each of the plurality of mobile terminals; forward transmitting the data, the base station controller grouping data to be transmitted to the plurality of mobile terminals according to the frame offsets to generate at least one multi-frame and calling a socket function to transmit the generated at least one multi-frame to a base station, and the base station demultiplexing the at least one multi-frame to transmit associated data to associated mobile terminals; and backward transmitting the data, the base station grouping data received from the mobile terminals according to the frame offsets to generate the at least one multi-frame and transmitting the at least one multi-frame to the base station controller through a called socket function, and the base station controller demultiplexing the at least one multi-frame and transmitting the demultiplexed at least one multi-frame to a mobile switching center.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a block diagram of an ATM (Asynchronous Transfer Mode) based wireless communication system;

FIG. 2 illustrates a procedure of transmitting and receiving voice frames in the ATM based wireless communication system shown in FIG. 1;

FIG. 3 is a block diagram of a wireless communication system using Fast Ethernet as a backbone network according to an embodiment of the present invention;

FIG. 4 illustrates a procedure of transmitting and receiving a voice frame in the Ethernet based wireless communication system shown in FIG. 3; and

FIG. 5 illustrates a format of the Ethernet frame shown in FIG. 4.

### DETAILED DESCRIPTION OF THE INVENTION

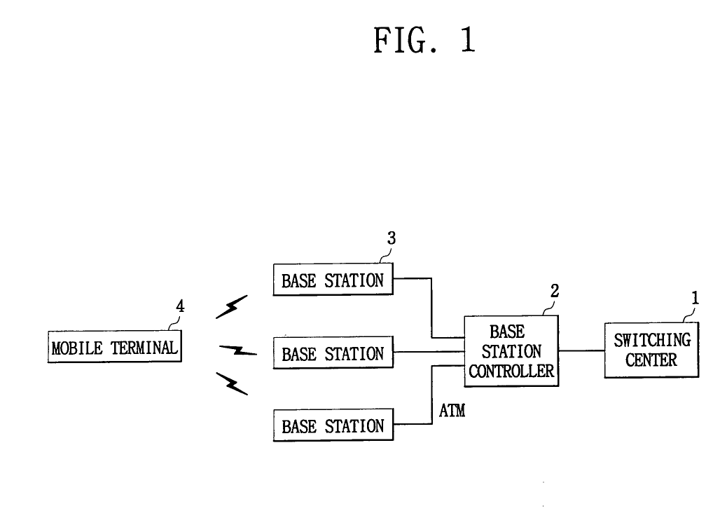

FIG. 1 is a block diagram of an ATM (Asynchronous Transfer Mode) based wireless communication system. Referring to FIG. 1, the wireless communication system includes a mobile switching center 1, a base station controller 2, base stations 3 and a mobile terminal 4. A wireless communication system typically employs an ATM network as a backbone network. Accordingly, the base station controller 2 and the base stations 3 are interconnected via an ATM interface.

The mobile switching center 1 performs a switching function in the wireless communication network, and serves to connect mobile subscribers to various additional equipment (e.g., Short Message Service (SMS), Voice Message Service (VMS) or the like) in the network to provide additional services or to connect mobile subscribers to other networks to provide the additional services.

The switching center 1 transmits and receives Pulse Code Modulation (PCM) data to and from the base station controller 2 via E1, and connects to a central office wired switch (not shown) to perform a wired switching function.

The base station controller 2 connects voice calls and circuit data calls between the base stations 3 and the mobile switching center 1, and connects packet data calls between the base stations 3 and a Data Core Network (DCN; not shown). The base station controller 2 performs vocoding for the voice calls and operates and maintains the base stations 3 under the control of Base Station Manager (BSM; not shown).

The base station controller 2 includes a Selection and Distribution Unit (SDU) to transmit and receive various data to and from the base stations 3. That is, the base station controller transforms voice frames, received from the mobile terminal 4 via the base station 3, to PCM data and sends the PCM data to the mobile switching center 1, and vocodes the PCM data received from the switching center 1 for transmission to the mobile terminal 4 via a channel card of the base station 3.

During a handoff, the base station controller performs a selection function of selecting one having the best condition of backward voice frames received from several base stations 3, and a distribution function of distributing a voice frame received from the switching center 1 to the several base stations 3.

The base station 3 (or base station transceiver system) matches the mobile terminal 4 wirelessly to provide mobile communication services to mobile subscribers.

The data transmission between the base station controller 2 and base stations 3 and the mobile terminal 4 in the above-configured ATM based wireless communication system is described below. More particularly, a description of a process for a first call setup between the base station 3 and the mobile terminal 4 has been omitted while a process of transmitting and receiving voice frames for voice service after a call setup has been completed between the base station controller 2 and base station 3 and the mobile terminal 4 is described below.

When the call setup is completed, the base station controller 2 and the base station 3 and the mobile terminal 4 transmit and receive voice frames every 20 ms for voice service. The transmission and reception of the voice frames every 20 ms provides normal voice service. Thus, each mobile terminal 4, to which a wireless channel has been allocated, transmits and receives voice frames to and from the wireless system once every at least 20 ms. In using the wireless channel with different mobile terminals, each mobile terminal is allocated a wireless channel at its given time point with a time difference therebetween. A voice frame is typically divided by sixteen frame offsets and is transmitted every 20 ms period. Accordingly, each mobile terminal transmits and receives voice frames at a time point corresponding to the frame offset allocated thereto.

When a voice frame is transmitted in an ATM based wireless system, a fixed cell of 53 bytes is transmitted via a physical layer whenever one packet is transmitted. The base station controller 2 transmits a voice frame to the mobile terminal 4 by determining a frame offset that has been allocated to an associated mobile terminal 4 and sends a forward frame to the associated mobile terminal 4 at a time corresponding to the determined frame offset in a 20 ms period.

The voice frame is sent from the base station controller 2 to the base station 3 in the form of an ATM Adaptation Layer 2 (AAL2) cell. The division of 20 ms by the sixteen frame offsets yields 1.25 ms, and the voice frame is transmitted from the base station controller 2 to the base station 3 at an associated 1.25 ms in a Global Positioning System (GPS) system time.

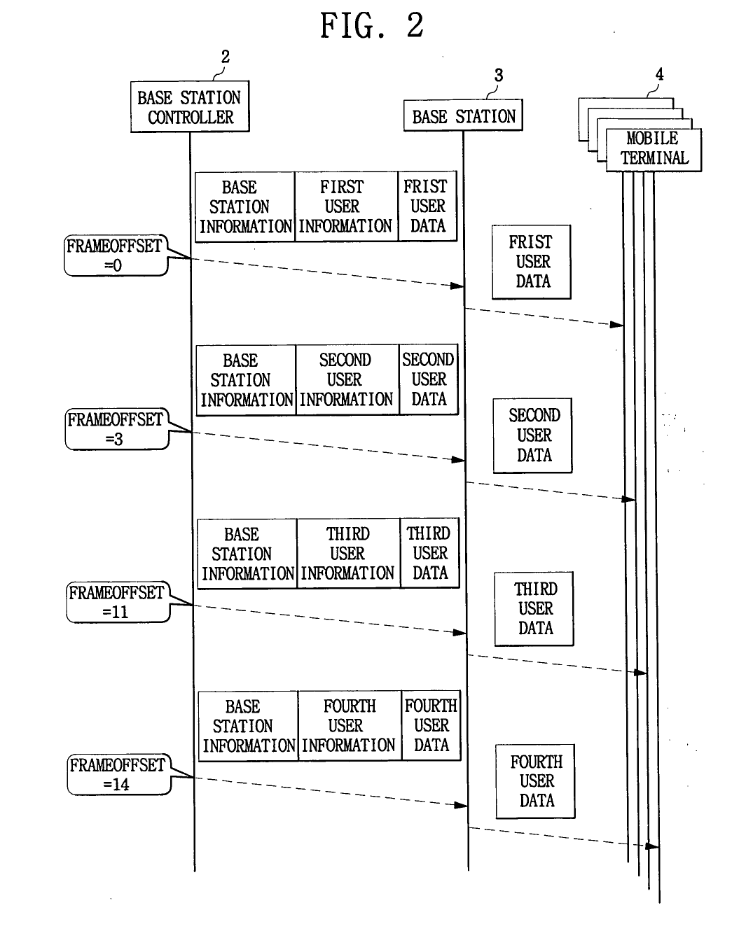

FIG. 2 illustrates a procedure of transmitting and receiving voice frames in the ATM based wireless communication system shown in FIG. 1. Referring to FIG. 2, when frame offset values are 0, 3, 11 and 14, respectively, the base station controller 2 transmits voice frames to the base station 3. Base station information, user information and user data are included in each voice frame sent from the base station controller 2 to the base station 3. The base station 3 receives its associated voice frame from the base station controller 2 and sends only the user data to an associated mobile terminal 4.

In an ATM system, an ATM device is included in both the base station controller 2 and the base station 3. Accordingly, an application software module, which is adapted to process voice frames in the base station controller 2, has only to perform from an initial function to a function of forwarding the voice frames to be sent to the ATM device included in the base station controller 2. Thereafter, communication is performed between ATM devices included in both the base station controller 2 and the base station 3 such that the voice frames are transmitted and received by hardware. The reason is that an ATM path has been allocated between the base station controller 2 and the base station 3 in advance.

Thus, if an ATM communication system is arranged between the base station and the base station controller, high-speed transmission in a lower layer is completed by hardware using the ATM devices.

The present invention will now be described more fully hereinafter with reference to the accompanying drawings, in which embodiments of the present invention are shown. The present invention may, however, be embodied in different forms and should not be construed as being limited to the embodiments set forth herein. Rather, these embodiments are provided so that this disclosure will be thorough and complete, and will filly convey the scope of the present invention to those skilled in the art. In the drawings, like numbers refer to like elements throughout the specification.

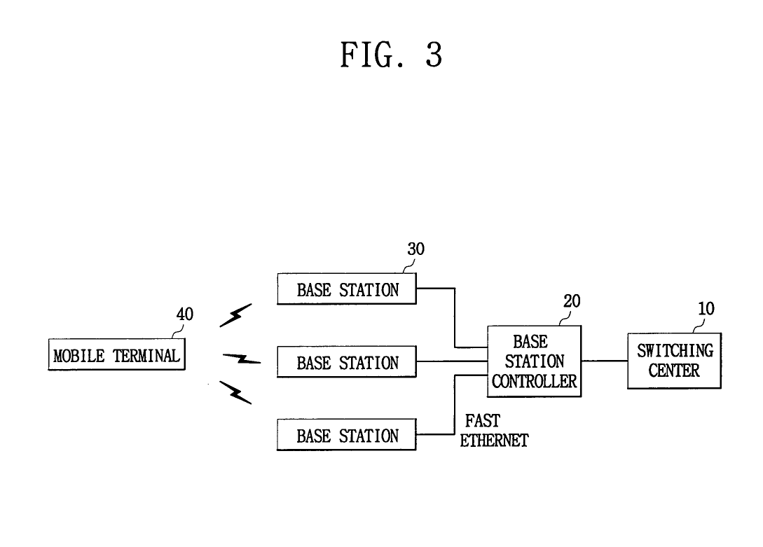

FIG. 3 is a block diagram of a wireless communication system using a Fast Ethernet system as a backbone network according to an embodiment of the present invention. Referring to FIG. 3, a base station controller 20 and a base station 30 in a wireless communication system are interconnected via the Fast Ethernet.

Hereinafter, an arrangement where the base station controller 20 and the base station 30 are interconnected via the fast Ethernet will be described, wherein the term Ethernet should be construed as the Fast Ethernet unless otherwise stated. However, the Fast Ethernet stated herein is an example of an Internet Protocol (IP) network that provides a speed range of from 10 Mbps to 100 Mbps, and therefore, the present invention is not limited to the Fast Ethernet and can employ a variety of IP networks such as Gigabit Ethernet, 10 Gigabit Ethernet, or Terabit Ethernet (Tbps).

In addition, voice frames are discussed below. The voice frames stated herein, however, are merely examples of data that can be transmitted and received in an IP based wireless communication system according to the present invention, and the present invention is applicable to other data and is not limited to voice frame data.

A mobile switching center 10 performs a switching function in the wireless communication network, and serves to connect mobile subscribers to various additional equipment (e.g., SMS, VMS or the like; not shown) in the network to provide additional services, or to connect to other networks to provide additional services.

The switching center 10 transmits and receives PCM data to and from the base station controller 20 via E1, and is connected to a central office wired switch (not shown) to perform a wired switching function.

The base station controller 20 connects voice calls and circuit data calls between the base station 30 and the switching center 10, and connects packet data calls between the base station 30 and the DCN (not shown). The base station controller 20 performs vocoding on the voice calls, and operates and maintains the base station 30 under the control of BSM (not shown).

The base station controller 20 includes a Selection and Distribution Unit (SDU) to transmit and receive voice frames to and from the base station 30 via the Ethernet. That is, it transforms voice frames, received from the mobile terminal 40 via the base station 30, into PCM data for transmission to the mobile switching center 10, and vocodes the PCM data received from the mobile switching center 10 to sends it to the mobile terminal 40 via a channel card of the base station 30 using the Fast Ethernet.

The base station controller 20 calls a socket function to send the voice frames, as is adapted to send the voice frames in the Ethernet environment. In addition, because it employs IP communication environment, the base station controller 20 continues to manage the process until the base station controller 20 sends the last voice frame to the base station 30.

If the base station controller 20 calls the socket function whenever the base station controller 20 sends voice frames to each mobile terminal 40, a system load becomes high. Accordingly, the base station controller 20 produces multi-frames by grouping the voice frames to be sent to several mobile terminals, and then calls the socket function to send the produced multi-frames. By doing so, it is possible to reduce the number of times that the socket function is called to send voice frames to each mobile terminal.

For this, the base station controller 20 allocates an arbitrary frame offset to the mobile terminal to which the call has been set up, and packetizes the voice frames to be sent to each mobile terminal for each frame offset to produce multi-frames. Then, it calls the socket function to transmit the multi-frames and transmits the multi-frames to the associated base station 30.

In addition, while the mobile terminal 40 is in a handoff, the base station controller 20 selects one having the best condition of backward voice frames received from several base stations 30 being in the handoff, and distributes the voice frames received from the switching center 10 to several base stations 30. Since selecting one having the best state of the backward voice frames received from several base stations 30 being in the handoff, and distributing the voice frame received from the switching center 10 to several base stations 30 are already known in the art, a detailed description thereof has been omitted.

The base station 30 (and hence the base station transceiver system) transmits and receives voice frames to and from the base station controller 20 via the Fast Ethernet, and wirelessly matches the mobile terminal 40 to provide the mobile subscriber with mobile communication services.

The base station 30 sends the voice frames received from each mobile terminal to the base station controller 20. When sending the voice frames to the base station controller 20, the base station 30 also calls the socket function for sending the voice frames, as the base station is adapted to send the voice frames in the Ethernet environment. In addition, the base station 30 continues to manage the process until it sends the last voice frame to the base station controller 20 because the base station 30 uses an IP communication environment.

If the base station 30 calls the socket function whenever it receives the voice frames from each mobile terminal 40 and sends the received voice frames to the base station controller 20, a system load becomes larger as well. Accordingly, the base station 30 groups and collects the voice frames received from several mobile terminals to produce a multi-frame, and then calls the socket function to send the produced multi-frame to the base station controller 20. By doing so, it is possible to reduce the number of times that the socket function is called in order to transmit the voice frames received from each mobile terminal to the base station controller 20.

If the base station 30 receives the voice frames from each mobile terminal to which a call has been set up, it packetizes the voice frames to produce the multi-frames. Then, the base station 30 calls the socket function to send the multi-frames to the base station controller 20 and sends the multi-frames to the base station controller 20 via the Fast Ethernet.

The process of transmitting and receiving the voice frames, which is performed between the base station controller 20 and base station 30, and the mobile terminal 40 in the Fast Ethernet based wireless communication system as configured above, is described below.

A description of the process of setting up a first call between the base station 30 and the mobile terminal 40 has been omitted herein and, rather, a process of transmitting and receiving voice frames for voice service after the call setup has been completed between the base station 30 and the mobile terminal 40 is described below.

After the call setup has been completed, the base station controller 20 and base station 30 and the mobile terminal 40 transmit and receive the voice frames every 20 ms for voice service. The transmission and reception of the voice frames every 20 ms is intended to provide a normal voice service. Accordingly, each mobile terminal 40 allocated a wireless channel transmits and receives the voice frames to and from the base station controller 20 via the base station 30 once every at least 20 ms. In using the wireless channel allocated to the mobile terminal, each mobile terminal 40 can use the wireless channel at its allocated time point with a time difference therebetween.

The base station controller 20 allocates a frame offset to the mobile terminal to which a call setup has been completed. Several methods of allocating the frame offset are available. For example, the frame offset can be allocated on the base station basis. That is, it is accomplished by allocating the frame offset to mobile terminals using the same base station.

For example, voice frame transmission can be performed with division of sixteen frame offsets in every 20 ms period. Accordingly, each mobile terminal transmits and receives the voice frames at a time point corresponding to the frame offset allocated thereto.

After allocating the frame offset to each mobile terminal, the base station controller 20 produces multi-frames by grouping the voice frames to be transmitted to each mobile terminal for each frame offset. Each multi-frame includes base station information, information on each mobile terminal, and real voice data. Since multi-frames are produced by grouping the voice frames corresponding to several terminals, the multi-frames are composed of information on several mobile terminals and voice frames to be transmitted to associated mobile terminals.

When a time point corresponding to an arbitrary frame offset occurs, the base station controller 20 transmits the produced multi-frames corresponding to the associated frame offset to an associated base station 36. The socket function is called to transmit the produced multi-frames. The socket function is called whenever the multi-frames produced for each frame offset are transmitted.

When a time corresponding to an arbitrary frame offset occurs, the base station controller 20 determines the multi-frames produced corresponding to the frame offset, in order to transmit the voice frames to the mobile terminal 40. If the associated multi-frames exists, the base station controller calls the socket function for transmitting the multi-frames to the associated base station.

For example, if it is assumed that sixteen frame offsets are allocated to each mobile terminal, dividing 20 ms by the sixteen frame offsets yields 1.25 ms and the voice frames are transmitted from the base station controller 20 to the base station 30 at an associated 1.25 ms in GPS system time.

That is, assuming that data processing for a maximum of 120 subscribers every 20 ms is performed in a forward media process, processing for 7 to 8 subscribers should be performed every 1.25 ms. Furthermore, during a handoff, if the base station controller 20 performs the handoff with a maximum of three base stations 30, it should transmit 21 to 24 voice frames to the base station 30 within 1.25 ms.

It is also necessary for both the forward data transmission and the backward data to be performed within 1.25 ms.

When communicating with the mobile terminals 40 using the same base station 30, the base station controller 20 allocates the same frame offset to the associated mobile terminals 40, and constructs and stores the voice frames to be sent to respective mobile terminals into multi-frames, and then sends the multi-frames through one socket function call. The base station 30 demultiplexes the multi-frames sent from the base station controller 20, and transmits the associated voice frames to the associated mobile terminals using a wireless coverage of the base station.

That is, if it is determined that the voice frames to be transmitted belong to the same base station 30, the base station controller 20 adds associated user information (terminal desired for communication) and user data (i.e., voice or data) to a message, and sends them to the base station 30.

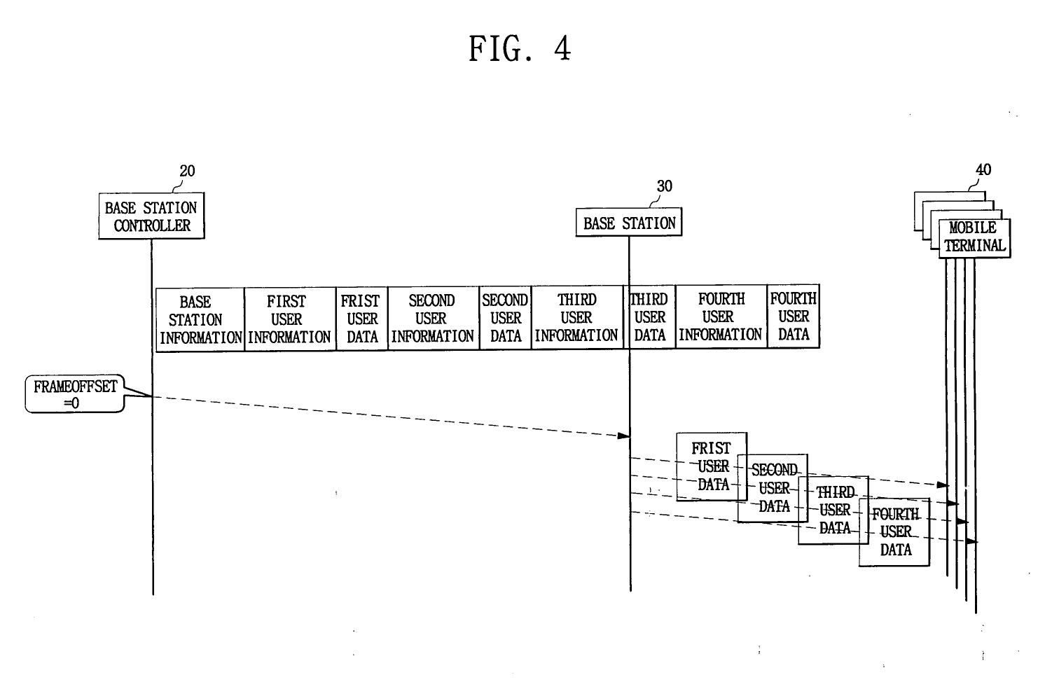

FIG. 4 illustrates a procedure of transmitting and receiving voice frames in the Ethernet based wireless communication system of FIG. 3. Referring to FIG. 4, when a value of a frame offset is zero, the base station controller 20 sends voice frames composed of multi-frames to a mobile terminal via the base station 30.

That is, if the frame offset is zero, base station information, first user information, first user data, second user information, second user data, third user information, third user data, fourth user information and fourth user data are included in the multi-frames sent from the base station controller 20 to the base station 30.

The base station controller 20 stores associated information for the multi-frames during a unit period, and then calls a socket function to send the stored multi-frames to an associated base station at a time when a time point corresponding to the associated frame offset occurs. When receiving this multi-frame data from the base station controller 20, the base station 30 extracts the voice frames for each mobile terminal by vocoding the multi-frame data. Accordingly, the base station 30 sends the first user data to the first user mobile terminal, the second user data to the second user mobile terminal, the third user data to the third user mobile terminal, and the fourth user data to the fourth user mobile terminal.

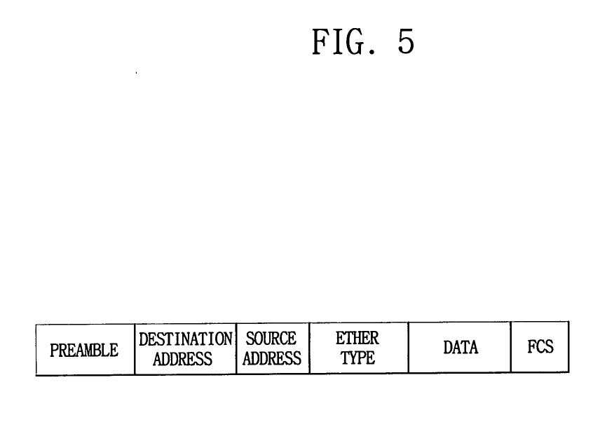

FIG. 5 illustrates a frame of the Ethernet arrangement of FIG. 4.

As seen in FIG. 5, data transmitted over the Ethernet is formed into a package type of frame. The present invention packetizes a plurality of data transmitted to each mobile terminal into one frame having an Ethernet frame format adapted to produce and send multi-frames. Respective fields are given as follows:

Preamble: this field occupies 8 bytes and indicates a start and end of a frame. A start frame is written with 0s and 1s and an end portion is written with ‘11’.

Destination Address: a portion in which a destination data-link address to which a frame is to be sent (=Mac address) is stored. If an address in this portion is represented as Is (=ff:ff:ff:ff:ff:ff), it means a broadcast frame and a frame corresponding thereto is transmitted to all Ethernet adopters.

Source Address: this field represents a data_link address of a station for sending a frame (=Mac Address).

EtherType: a field indicating what protocol type is associated with a frame, and including IP (EtherType 0x0800), ARP (0x0806), AppleTalk (0x809B) or the like.

Data: data handed over from a higher layer is stored herein. This field is required to have a size between 46 and 1500 bytes. If data of 46 bytes or less is received from the high level layer, dummy data is added so that the field becomes a minimum of 46 Bytes. In addition, when the data has a size over 1500 bytes, it is divided for the purpose of transmission.

FCS: an abbreviation of Frame Check Sequence, called CRC, which occupies four bytes, and is used to check a frame error.

Meanwhile, in case of UDP in the CSMA/CD system communication, it can be seen that if it is less than 1500 bytes, a system load becomes high due to transmission frequency (function calling frequency) regardless of packet size. Generally, a voice frame is less than hundreds of bytes, including a message header. In this case, delay due to reassembling on the network and hence frequent socket function calling are reduced by configuring and transmitting multi-frames to be less than 1500 bytes being MAX_PDU_SIZE in which it is unnecessary to reassemble the packet of the UDP layer, resulting in enhanced performance in an entire system.

Moreover, assuming that subscriber processing for 30 users every subcell is performed, it will be accomplished using only four frame offsets rather than sixteen frame offsets. It makes it possible to perform SDU and vocoding functions every 5 ms other than 1.25 ms, thereby greatly reducing the system load. These functions are applied to data communication as well as to voice communication.

According to the present invention, when a base station controller or a base station needs to send data to a correspondent during transmission and reception of various data between the base station controller and the base station in a wireless system in which the base station controller and the base station are interconnected over an IP network, it is possible to reduce practical data transmission times by grouping data for each frame offset and transmitting the resultant multi-frames for the purpose of transmission without calling a socket function whenever data is transmitted for each mobile terminal, thereby effectively reducing the number of times that the socket function is called. Consequently, a system load can be reduced and in turn system resources can be effectively used.

1. A method comprising:
allocating frame offsets to a plurality of mobile terminals in a base station controller, a call being set up for each of the plurality of mobile terminals;
grouping data to be sent to the plurality of mobile terminals according to the frame offsets allocated in the base station controller and generating at least one multi-frame; and
transmitting the generated at least one multi-frame from the base station controller to a base station.

2. The method of claim 1, further comprising demultiplexing the at least one multi-frame received from the base station controller in the base station and transmitting associated data to associated mobile terminals.

3. The method of claim 1, further comprising connecting the base station controller to the base station by an Internet Protocol (IP) network.

4. The method of claim 1, wherein the data includes at least one of a voice frame and a data frame.

5. The method of claim 1, wherein the at least one multi-frame includes information on the base station, information on at least one mobile terminal using the base station, and data to be sent to each of the plurality of mobile terminals.

6. The method of claim 1, further comprising differently allocating the frame offsets to each base station, so that identical frame offsets are allocated to the same base station.

7. A method comprising:
allocating frame offsets to a plurality of mobile terminals in a base station controller, a call being set up for each of the plurality of mobile terminals;
grouping data received from the plurality of mobile terminals according to frame offsets at a base station and generating at least one multi-frame; and
transmitting the generated at least one multi-frame from the base station to the base station controller.

8. The method of claim 7, further comprising demultiplexing the at least one multi-frame in the base station controller and transmitting the demultiplexed at least one multi-frame to a mobile switching center.

9. The method of claim 7, further comprising connecting the base station controller to the base station by an IP network.

10. The method of claim 7, wherein the data includes at least one of a voice frame and a data frame.

11. The method of claim 7, wherein the at least one multi-frame includes information on the base station, information on at least one mobile terminal using the base station, and data to be sent to each of the plurality of mobile terminals.

12. The method of claim 7, further comprising differently allocating frame offsets to each base station, so that identical frame offsets are allocated to the same base station.

13. A method comprising:
allocating frame offsets to a plurality of mobile terminals in a base station controller, a call being set up for each of the plurality of mobile terminals;
forward transmitting the data, the base station controller grouping data to be transmitted to the plurality of mobile terminals according to the frame offsets to generate at least one multi-frame and calling a socket function to transmit the generated at least one multi-frame to a base station, and the base station demultiplexing the at least one multi-frame to transmit associated data to associated mobile terminals; and
backward transmitting the data, the base station grouping data received from the mobile terminals according to the frame offsets to generate the at least one multi-frame and transmitting the at least one multi-frame to the base station controller through a called socket function, and the base station controller demultiplexing the at least one multi-frame and transmitting the demultiplexed at least one multi-frame to a mobile switching center.

14. A program storage device, readable by a machine, tangibly embodying a program of instructions executable by the machine to perform a method comprising:
allocating frame offsets to a plurality of mobile terminals in a base station controller, a call being set up for each of the plurality of mobile terminals;
grouping data to be sent to the plurality of mobile terminals according to the frame offsets allocated in the base station controller and generating at least one multi-frame; and
transmitting the generated at least one multi-frame from the base station controller to a base station.

15. The program storage device of claim 14, the method further comprising demultiplexing the at least one multi-frame received from the base station controller in the base station and transmitting associated data to associated mobile terminals.

16. A program storage device, readable by a machine, tangibly embodying a program of instructions executable by the machine to perform a method comprising:
allocating frame offsets to a plurality of mobile terminals in a base station controller, a call being set up for each of the plurality of mobile terminals;
grouping data received from the plurality of mobile terminals according to frame offsets at a base station and generating at least one multi-frame; and
transmitting the generated at least one multi-frame from the base station to the base station controller.

17. The program storage device of claim 16, the method further comprising demultiplexing the at least one multi-frame in the base station controller and transmitting the demultiplexed at least one multi-frame to a mobile switching center.

18. A program storage device, readable by a machine, tangibly embodying a program of instructions executable by the machine to perform a method comprising:
allocating frame offsets to a plurality of mobile terminals in a base station controller, a call being set up for each of the plurality of mobile terminals;
forward transmitting the data, the base station controller grouping data to be transmitted to the plurality of mobile terminals according to the frame offsets to generate at least one multi-frame and calling a socket function to transmit the generated at least one multi-frame to a base station, and the base station demultiplexing the at least one multi-frame to transmit associated data to associated mobile terminals; and
backward transmitting the data, the base station grouping data received from the mobile 11 terminals according to the frame offsets to generate the at least one multi-frame and transmitting the at least one multi-frame to the base station controller through a called socket function, and the base station controller demultiplexing the at least one multi-frame and transmitting the demultiplexed at least one multi-frame to a mobile switching center.
